(19) United States
(12) Patent Application Publication
(10) Pub. No.: US 2011/0313952 A1
(43) Pub. Date: Dec. 22, 2011

(54) SYSTEM FOR MONITORING REAL ORGANIZATIONS

(76) Inventor: Ofer Agam, Daly City, CA (US)

(21) Appl. No.: 12/819,967

(22) Filed: Jun. 21, 2010

(51) Int. Cl. G06Q 99/00; G06Q 40/00; G06Q 50/00; G06Q 10/00

(52) U.S. Cl. 705/500; 705/12; 705/37; 705/319

(57) ABSTRACT

The invention is a system for monitoring real organizations, the system having a digital community of participating member organizations which like a shadow, follow the operations of real organizations, where a shadow organization promotes transparency of a counterpart real organization's operations by illuminating, scrutinizing and informing a global public forum on the actions of the counterpart real organization; and players, where a player is a voting citizen member of the digital community, and can optionally actively participate as an employee of a clear shadow organization. The clear shadow organization can be founded by the real organization, such as the counterpart real company, or another real entity. To heighten interest the system can include a gaming component, where players and organizations are recognized, even rewarded, for their success at achieving transparency. The digital community embraces all people, from all over the world, with one precondition: civility must be observed and practiced.

### FIELD OF THE INVENTION

The invention relates to a system for monitoring real organizations, where the system includes a digital community having participating member organizations, which like a shadow, follow the operations of a real organization, where a shadow organization promotes transparency of a counterpart real organization's operations by illuminating, scrutinizing, and informing a global public forum on the actions of the counterpart real organization.

### BACKGROUND OF THE INVENTION

North Link College in Johannesburg South Africa teaches a course where a simulated company mirrors the structure, function and operations of a real company, but without real money exchanging hands. The simulated enterprise is a mock company that mirrors the structure, function and operations of a real company. According to the Course Description, the simulated company results in a non-threatening learning environment where learners acquire practical skills. The simulated company is a soft drink retailer called Quench Emporium. Student-employees learn the inter-dependence of departments, the importance of liaising with colleagues, safety and security measures, and control mechanisms that exist in companies for handling money. The students deal with incoming and outgoing mail and petty cash using corporately and legally correct procedures. They hone their communication and inter-personal skills when dealing with visitors. Learners understand the importance of accuracy and cross-referencing documents, for example when receiving stock. During induction training employees are taught telephone etiquette, message taking as well as operating a mini-switchboard and dealing with customer queries and complaints on the phone. The students are exposed to the use of office equipment such as sending faxes and making photocopies. They use computer business applications, particularly as they apply to the protocol of cash handling procedures for retail sales. They acquire valuable life skills like learning the documentation and process for making bank deposits and paying accounts for stack suppliers, and purchasing from other simulated enterprises.

Through the daily routine of stock control and movement, employees of four different departments have to liaise, correlate information and communicate with each other. Their calculation skills are enhanced and they gain an understanding of the importance of completing documentation accurately as they do a daily stock take, requisition merchandise from the store to the shop, record stock on hand and on order and complete purchase requisitions and orders for new stock.

Furthermore the Course Description states that the students learn safety and security measures when moving stock as well as the principles and terminology of display, first in first out, face front and house keeping.

Activities are generated through memos from facilitators, trading with other simulated enterprises, including banks, municipalities and communication companies. The students also are taught the recruitment process, how to calculate taxes, benefits, gross and net salaries.

In the marketing department employees have to master a variety of advertising and marketing communication methods and strategies. They also calculate profits, discounts etc. for promotions and sales. North Link College asserts that the marriage between knowledge and applied competence or skill is one of the purest forms of Order of the British Empire (OBE). By equipping learners with hard and soft skills their employability is increased, the induction training period is reduced and, as new employees, they can make a valuable contribution to the company immediately as they complete their college education with a year's working experience.

### SUMMARY OF THE INVENTION

The invention is a system for monitoring real organizations that includes a digital community of participating member organizations which like a shadow, follow the operations of a real organization, where a shadow organization promotes transparency of a counterpart real organization's operations by illuminating, scrutinizing and informing a global public forum of the actions of the counterpart real organization; and players, where a player is a voting citizen member of the digital community, and can optionally actively participate as an employee of a clear shadow organization. The clear shadow organization can be founded by the real organization, such as the counterpart real company, or another real entity such as an individual, a company, an association of companies, a lobbyist, a politician, a country, a state, a city, a county, a church, a governmental agency, a citizen, a club and an activist. The system can include that the digital community of participating members is virtual and exists on a social network, and to heighten interest the system can include a gaming component, where players and organizations are recognized, even rewarded, for their success at achieving transparency. The digital community embraces all people, from all over the world, with only one precondition: civility must be observed and practiced. The system can include governing councils, where governing councils set and enforce the covenants of the digital community. The governing councils would include a civility council, having members elected by participating players, where the civility council establishes rules of civility—defining what is civil, and what is not. Because it is an elected body civility rules are subject to change. Players, who object to any civility rule are invited to run against any civility council member, by campaigning based on his or her vision/mission/goal statements.

In addition to defining civility, the civility council, any clear shadow organization, and any player can issue opinions on how to deal with issues around the world. This is particularly relevant where violence and abuse are common, usually stemming from no or poor access to education, and/or exposure to bad influences during the formative years of people, especially young people. Opinions issued by the civility council are as an independent body, and need not reflect those of all members of the entire digital community.

The system of governing councils can further include a transparency council, having members elected by participating players, where the transparency council establishes a rubric to rate the level of transparency—quantifying the transparency in terms of a composite Transparency Index that the real organization has achieved, either through actual public actions, reports released to the public by the real organization, or reports released by the clear shadow organization. The composite Transparency Index will be published, presented numerically and graphically on any media that clarifies issues absolutely and/or comparatively, for instance by industry, geographically, by size, for profit, non-profit, etc. The published Transparency Index will stimulate competition, and compel nonmember organizations to join to improve their image. Because the transparency council is an elected body the rubric of the Transparency Index is subject to change.

In the invented system, players can challenge the digital community to change its bylaws, rules, regulations, or guidelines as established by the various governing councils. Recall, the digital community of the system has at least one clear shadow organization, where a clear shadow organization shadows the operations of a real organization, and is founded by a real organization or another real entity such as an individual, a company, an association of companies, lobbyist, politicians, governmental agencies, citizens, clubs and activists, where the clear shadow organization's charter is to promote transparency of the real entity's operations, in effect providing a window into the operations of the real organization. The clear shadow organization produces Useful, concrete and tangible benefits as a consequence of the operational transparency including that the real organization is able to facilitate the solution of problems and mitigate poor corporate behavior, such as hiding quality defects, secret payments, financial improprieties, religious, racial and moral intolerance, and abuse. Meetings of all governing councils and all clear shadow organizations are open to all players.

In the case where the real organization is the founder, it must also be a sponsor, where the sponsor provides funding for the operation of the clear shadow organization. The initiation of the formation of a clear shadow organization by another real entity can be done without the blessing/consent of the real organization, and the formed organization is designated an unsponsored shadow organization. Typically, the real organization is given the opportunity to become the sponsor, and at any point the real organization can decide to join the unsponsored clear shadow organization as a co-founder, turning it into a sponsored clear shadow organization. Failing that, players, including individuals of the initiating entity can run for the position of founder. The elected founder is rewarded. The founder, as part of his running campaign, publishes a mission statement and goals for the unsponsored clear shadow organization, which then is published when the organization is formed.

In one aspect of the game component, players who become board members can buy shares in more than one clear shadow organization, whereas players who have never attained the rank of board member are limited to ownership in just one clear shadow organization. The unique position of a board member to buy stock in more than one organization encourages the player to attain the rank of becoming a member of the board, which is substantially the highest level of policy making. Board members are encouraged to seek positions on the governing councils.

The game has a game coinage, that is an analog to a real currency, such as the US dollar, Canadian dollar, Japan yen, European euros, Mexican peso, Chinese yuan, Russian rouble, etc. In one variation, the game also has an Application Programming Interface (API) that permits coin exchange and sharing amongst players playing in more than one game running on the social network. Typically, to convert real currency into game currency there is a modest discount charge. The social network serves principally as a virtual shared location on the Internet, where a large number players can operate largely anonymously to provide feedback through the clear shadow organization. Here forth in this application, a real organization is broadly defined to include a real individual, business, institution, company, charity, or sovereign state or governmental body thereof which enforces laws, makes laws, sets policies, makes disbursements, and typically has religions and armies. The clear shadow organization is preferably sponsored by the real organization in the spirit that transparency is a barrier to poor behavior being rewarded, and that poor behavior will be caught earlier, and as such, the net effect is that harm is mitigated, because in the absence of transparency poor behavior goes on longer resulting in greater damage. The real organization can use the clear shadow organization to test new ideas and policies. New ideas and policies can be submitted to the clear shadow organization anonymously or in person, without fear of reprisal. Social networking encourages frank discussion, and builds camaraderie amongst a diverse group of individuals, across borders and oceans. The system, conducted as a game, recognizes players who take an active role in the digital community, and in particular the clear shadow organizations, but allows players to participate at any desired level, and in activities selected by the player. Participation comes in various forms, including actively working as an employee in a clear shadow organization, bringing income into the clear shadow organization, providing leadership, expertise, sharing knowledge of events and actions, evaluating performance as gauged in transparency versus secrecy, reporting on moral and ethical issues, providing testimony, publication of salaries and bonuses of the real organization top management, executive perks, trips, environmental accidents, overall quality and efficiencies of manufacturing, abuses and discriminations; and, where appropriate, lawsuits and investigations.

At the policy making level of the clear shadow organization, players of the game are rewarded for contributing their personal assets and involvement, with rewards being commensurately larger for attaining higher policy making positions in the organization. The hierarchy of rewards adds a level of competition and gamesmanship. Players are enticed by larger awards and greater recognition of achievement Players are rewarded if they attain a higher policy making position or if the policy making position improves the real organization's image, such as by solving problems and mitigating poor corporate behavior, such as hiding quality defects, secret payments, financial improprieties, religious, racial and moral intolerance, and abuse.

A clear shadow organization is recognized by the digital community for bringing more organizations and players into the digital community, and otherwise helping the digital community to grow. Real organizations which are companies are potentially rewarded by higher stock prices, better products, and a better public image. Typically, the value of game shares of the clear shadow organization is indexed to the value of real shares.

Another aspect of the invention is that it is a computer-readable medium having a computer-executable application for the digital community of participating members of a game running on a social network, that when executed on at least one processor includes the following: a computer-executable module for a real organization to establish a clear shadow organization that is a sponsored by the real organization, where the sponsored clear shadow organization is a transparent projection of the operations and activities of the real organization; a computer-executable module for a real entity to establish a clear shadow organization that is not sponsored by the real organization, where the unsponsored clear shadow organization, with or without the blessing of the shadowed real organization, attempts to disclose an accurate transparent projection of the operations and activities of the real organization; a computer-executable module for a player to conduct transactions with real and clear shadow organizations and optionally to participate as an employee in clear shadow organizations in various positions—some of which have policy making power; and a computer-executable administrative module for managing the digital community governing councils, transactions for participating organizations, entities and players. The computer-executable administrative module can be an element of a social networking site, where the social networking site is hosting the game.

It is anticipated that there will be dissenting view points of a third party (either a real entity, a real organization or a third party shadow organization) as to whether an exiting clear shadow organization is accurately reflecting its counterpart real organization. A venue for voicing this dissent is to form a dissenting clear shadow organization. The system can further include dissenting third party clear shadow organization which shadows the existing clear shadow organization. It is further anticipated that two or more organizations can merge where they have mutual interests. For example countries Jordan and Israel could each have clear shadow organizations, and these organizations could merge to settle policy disputes over water preservation and management. The resulting shadow organizations can then form new economic zones.

The invented system rewards operating in clear view of the world. Additionally, the system enables players to have a good time in-part through potential rewards, meet people with similar interest, and build a better free market, and possibly a better world, because sunlight shines where before there was darkness.

### BRIEF DESCRIPTION OF THE DRAWINGS

The foregoing and other objects will become more readily apparent by referring to the following detailed description and the appended drawings in which:

FIG. 1a-1c is a method for a computer executable module for a sponsored shadow organization;

FIG. 2a-2c is a method for a computer executable module for an unsponsored shadow organization;

FIG. 3a-3b is a method for a computer-executable module for a player; and

FIG. 4 is a method for a computer-executable administrative module for managing the digital community governing councils, transactions for participating organizations, entities and players.

### DETAILED DESCRIPTION OF THE INVENTION

A system for monitoring real organizations that includes a digital community of participating member organizations which like a shadow, follow the operations of a real organization, where a shadow organization promotes transparency of a counterpart real organization's operations by illuminating, scrutinizing and informing a global public forum of the actions of the counterpart real organization; and players, where a player is a voting citizen member of the digital community, and can optionally actively participate as an employee of a clear shadow organization. The clear shadow organization can be founded by the real organization, such as the counterpart real company, or another real entity such as an individual, a company, an association of companies, lobbyist, politicians, governmental agencies, citizens, clubs and activists. In the illustrated embodiment of the system the digital community of participating members is virtual and exists on a social networking site, such as Facebook™, Myspace™, etc. A list of social networking sites can be found on Alex.com™, Yahoo™, and Google™.

To heighten interest the system can include a gaming component, where players and organizations are recognized, even rewarded, for their success at achieving transparency.

There are various ways in which all players can obtain game coins aside from purchasing them with real money or transferring them from another game. A real or shadow organization or both can entice players to join the shadow organization by, for example: paying a player if he watches a video, typically a public relations video; giving out prize money in the form of game coinage for a sponsored event such as an event seeking ideas; giving out prize money in the form of game coinage when the idea is implemented; remunerating the player for participating in on-line/phone scheduled live events; and paying the player game coinage for recruiting others (i.e. friends) to join the shadow organization. Of course, after a player buys or is elected to a position he/she is typically remunerated and or receives accolades as a winner.

The digital community embraces all people, from all over the world, and the system is inclusive, with only one precondition: civility must be observed and practiced. The system has an administrative component, and a preferred embodiment of the administrative component includes governing councils, where governing councils set and enforce the covenants of the digital community. The governing councils include a civility council, having members elected by participating players, where the civility council establishes rules of civility—defining what is civil, and what is not. Because it is an elected body civility rules are subject to change. Players, who object to any civility rule are invited to run against any civility council member, by campaigning based on his or her vision/mission/goal statements.

The system's administration component of governing councils further includes a transparency council, having members elected by participating players, where the transparency council establishes a rubric to rate the level of transparency—quantifying the transparency rating that the real organization has achieved, either through actual public actions, reports released to the public by the real organization, or reports public released by the clear shadow organization. Because the transparency council is an elected body transparency rubrics are subject to change.

The invented system in one variation is implemented using computer executable modules. There is computer executable module for a sponsored shadow organization module, an unsponsored shadow organization module, a player module and an administration module.

In one variation, the invented modules are accessible on a computer-readable medium having a computer-executable application for the digital community of participating members of a game running on a social network, that when executed on at least one processor includes the following: a computer-executable module for a real organization to establish a clear shadow organization that is sponsored by the real organization, where the sponsored clear shadow organization is a transparent projection of the operations and activities of the real organization; a computer-executable module for a real entity to establish a clear shadow organization that is not sponsored by the real organization, where the unsponsored clear shadow organization, with or without the blessing of the shadowed real organization, attempts to disclose an accurate transparent projection of the operations and activities of the real organization; a computer-executable module for a player to conduct transactions with real and clear shadow organizations and optionally to participate as an employee in clear shadow organizations in various positions—some of which have policy making power; and a computer-executable administrative module for managing the digital community governing councils, transactions for participating organizations, entities and players. The computer-executable administrative module can be an element of a social networking site, where the social networking site is hosting the game.

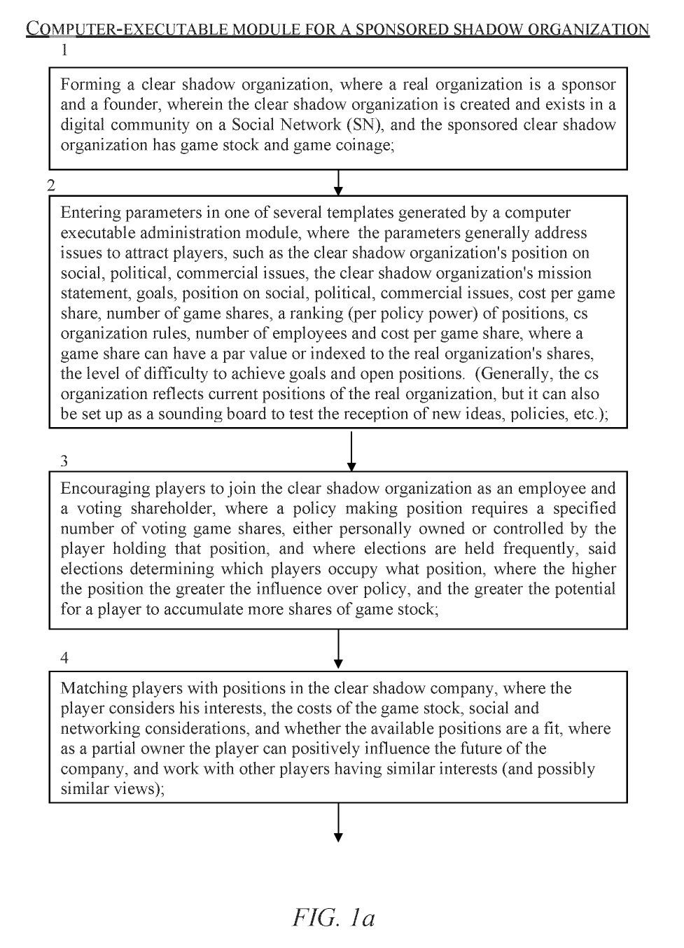

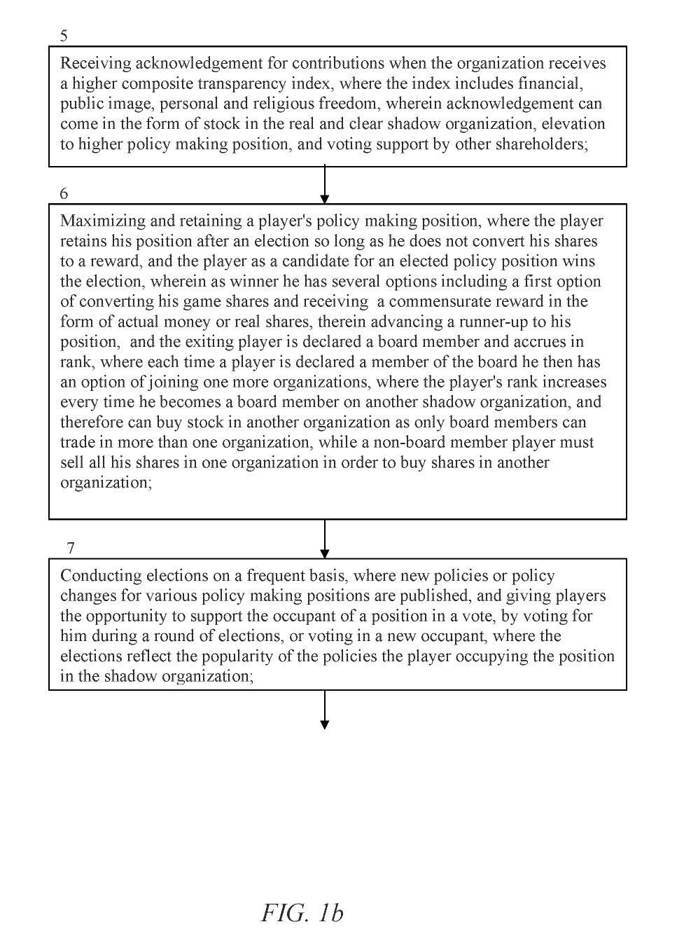

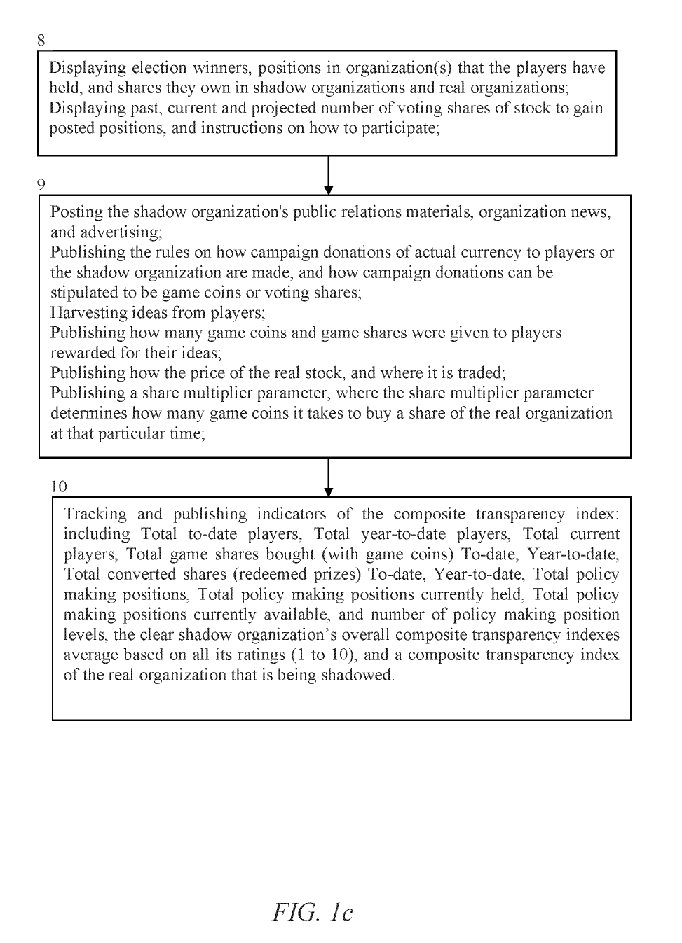

Referring to FIG. 1a-c, the method includes: Forming a clear shadow organization, where a real organization is a sponsor and a founder, wherein the clear shadow organization is created and exists in a digital community on a Social Network (SN), and the sponsored clear shadow organization has a game stock and a game coinage;

Entering parameters in one of several templates generated by a computer executable administration module, where the parameters generally address issues to attract players, such as the clear shadow organization's position on social, political, commercial issues; the clear shadow organization's mission statement, goals, position on social, political, and commercial issues; its cost per game share, number of game shares, a ranking (per policy power) of positions; the clear shadow organization rules, number of employees and cost per game share, where a game share can have a par value or an value indexed to the real organization's shares; the level of difficulty to achieve organizational goals; and the open positions. (Generally, the clear shadow organization reflects current positions of the real organization, but it can also be set up as a sounding board to test the reception of new ideas, policies, etc.).

Encouraging players to join the clear shadow organization as an employee and a voting shareholder, where a policy making position requires a specified number of voting game shares, either personally owned or controlled by the player holding that position, and where elections are held frequently, said elections determining which players occupy what position, where the higher the position the greater the influence over policy, and the greater the potential for a player to accumulate more shares of game stock. The following steps can also be included step of the method.

Matching players with positions in the clear shadow organization, where the player's considers his interests, the costs of the game stock, social and networking considerations, and whether the available positions are a fit, where as a partial owner the player can positively influence the future of the organization, and work with other players having similar interests (and possibly similar views);

Receiving acknowledgement for contributions when the real organization receives a higher composite transparency index, where the index includes financial, public image, personal and religious freedom, wherein acknowledgement can come in the form of stock in the real and clear shadow organization, elevation to higher policy making position, and voting support by other shareholders;

Maximizing and retaining a player's policy making position, where the player retains his position after an election so long as he does not convert his shares to a reward, and the player as a candidate for an elected policy position wins the election, wherein as winner he has several options including a first option of converting his game shares and receiving a commensurate reward in the form of actual money or real shares, therein making placing a runner up next in line to assume his position, and the exiting player is declared a board member and accrues in rank, where each time a player is declared board member, he then has an option of joining one or more organizations, where the player's rank increases every time he becomes a board member on another shadow organization, where joining another organization he can buy stock in another organization. Only board members can trade in more than one organization, while non-board member players must sell all their shares in one organization in order to buy shares in another organization.

Conducting elections on a frequent basis, where new policies or policy changes for various policy making positions are published, therein giving players the opportunity to support the occupant of a position in a vote, by voting for him during a round of elections, or voting in a new occupant, where the elections reflect the popularity of the policies of the player occupying the position in the shadow organization;

Displaying election winners, organization positions they have held, shadow and real shares they bought;

Displaying past, current and projected number of voting shares of stock to gain posted positions, and instructions on how to participate;

Posting the shadow organization's public relations materials, organization news, and advertising;

Publishing the rules on how campaign donations of actual currency to players or the shadow organization are made, and how campaign donations can be stipulated to be game coins or game voting shares;

Harvesting ideas from players;

Publishing how many game coins and game shares were given to players rewarded for their ideas;

Publishing the price of the real stock, and where it is traded;

Publishing a share multiplier parameter, where the share multiplier parameter determines how many game coins it takes to buy a share of the real organization at that particular time; and

Tracking and publishing employment statistics for the clear shadow organization, selected from the composite transparency index: including Total to-date players, Total year-to-date players, Total current players, Total game shares bought (with game coins) To-date, Year-to-date, Total converted shares (redeemed prizes) To-date, Year-to-date, Total policy making positions, Total policy making positions currently held, Total policy making positions currently available, and number of policy making position levels. The clear shadow organization's overall composite transparency index's average based on all its ratings (1 to 10), and a composite transparency index of the real organization that is being shadowed.

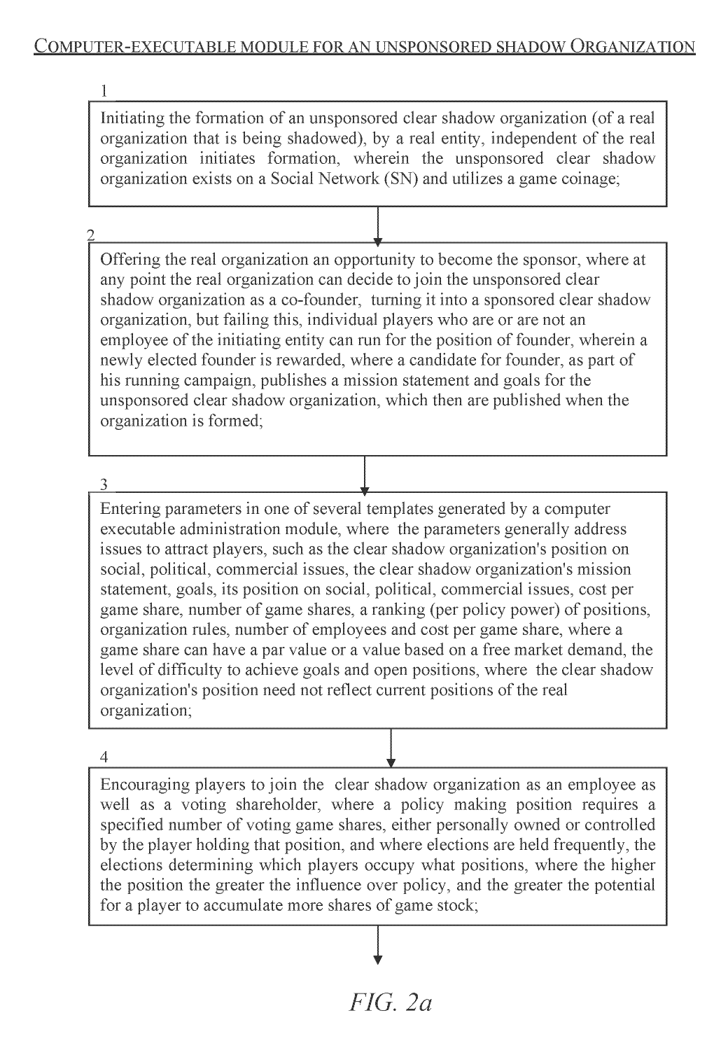

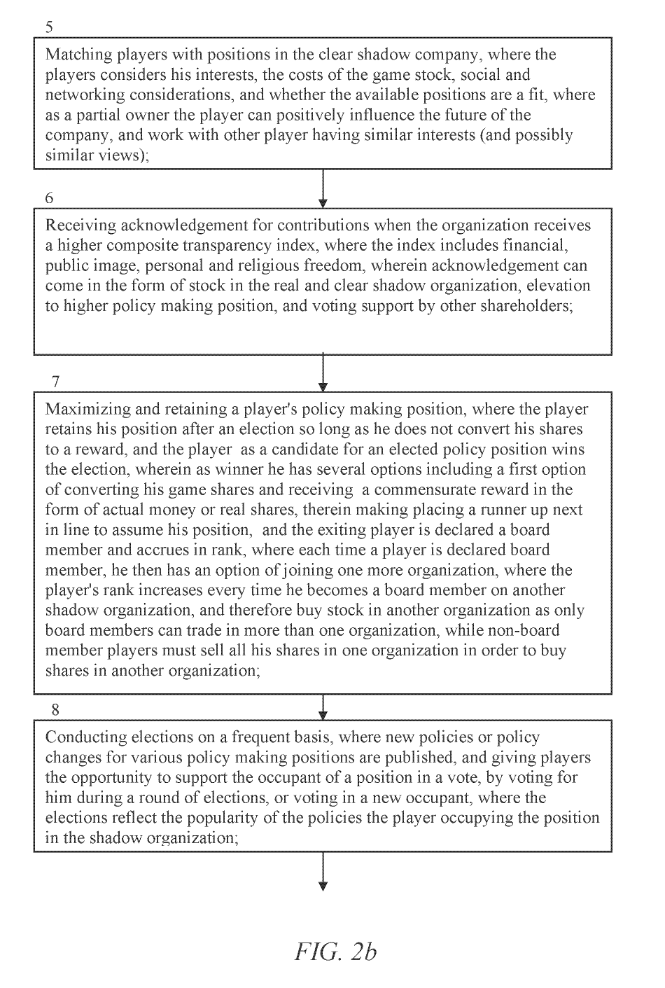

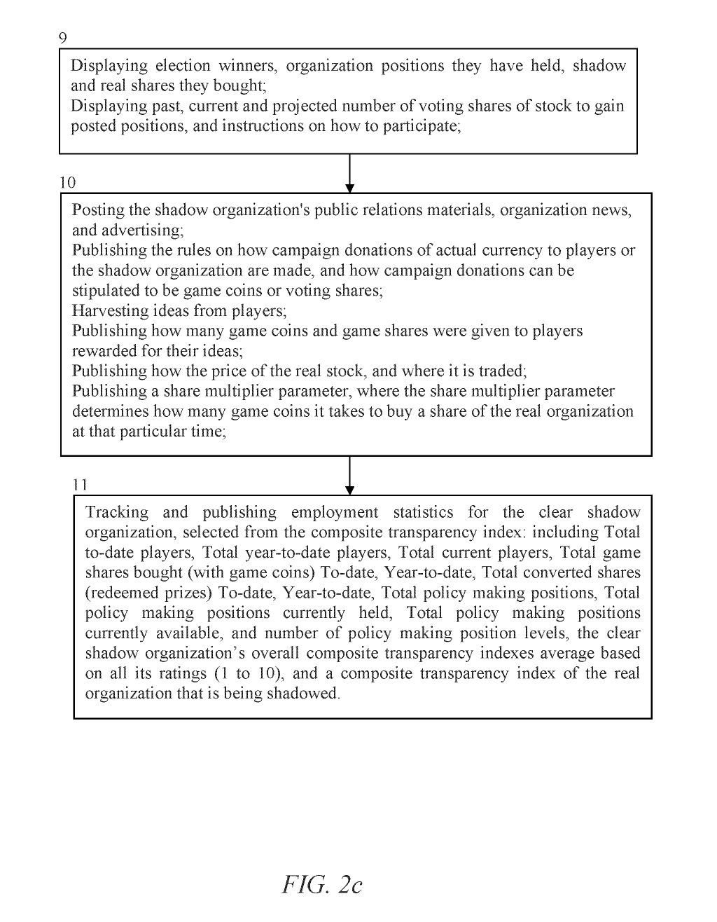

Referring to FIG. 2, the method includes: Initiating the formation of an unsponsored clear shadow organization (of a real organization that is being shadowed), is done by a real entity, independent of the real organization, wherein the unsponsored clear shadow organization exists on a Social Network (SN) and utilizes a game coinage. For instance, assume that the real organization does not want transparency for a variety of reasons, but a real entity wants to draw attention to the real organization. Independently, the real entity starts the clear shadow organization. Several real-life examples are illustrative of the situation.

The method further includes: Offering the real organization an opportunity to become the sponsor, where at any point the real organization can decide to join the unsponsored clear shadow organization as a co-founder, turning it into a sponsored clear shadow organization, but failing this, individual players who are or are not an employee of the initiating entity can run for the position of founder, wherein a newly elected founder is rewarded, where a candidate for founder, as part of his running campaign, publishes a mission statement and goals for the unsponsored clear shadow organization, which then are published when the organization is formed.

As a now sponsored clear shadow organization the sponsored organization can then proceed substantially as outlined in FIG. 1.

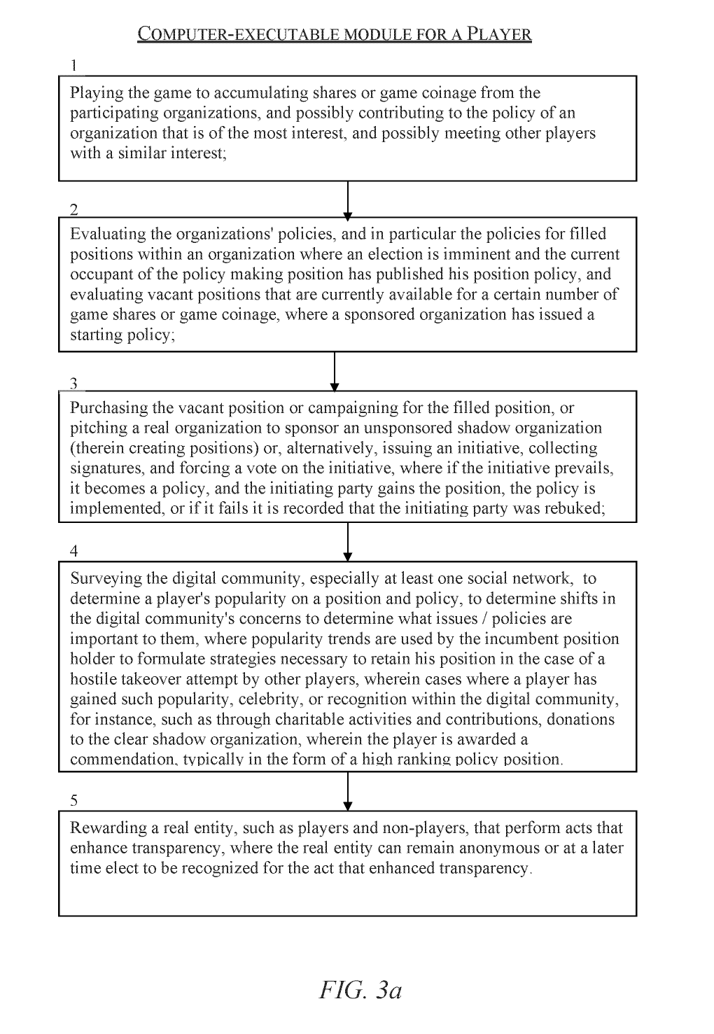

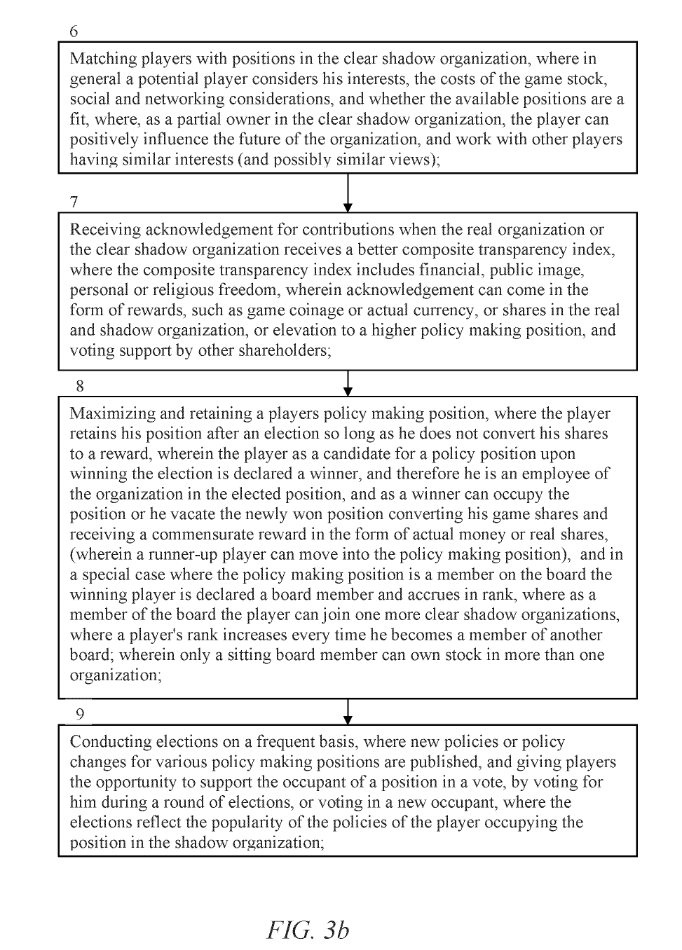

Referring to FIG. 3, the method includes: Playing the game to accumulate shares or game coinage from the participating shadow organizations, and possibly contributing to the policy of the shadow organization that is of the most interest, and possibly meeting other players with a similar interest are the goals of most players;

Evaluating the shadow organization's policies, and, in particular, the policies for filled positions within the shadow organization where an election is imminent and the current occupant of the policy making position has published his position policy, and evaluating vacant positions that are currently available for a certain number of game shares or game coinage, where a sponsored shadow organization has issued a starting policy;

Purchasing the vacant position or campaigning for the filled position, or pitching a real organization to sponsor an unsponsored shadow organization (therein creating positions) or, alternatively, issuing an initiative, collecting signatures, and forcing a vote on the initiative, where if the initiative prevails, it becomes a policy, and the initiating party gains the position, the policy is implemented, or if it fails it is recorded that the initiating party was rebuked;

The method can further include: Surveying the digital community, especially at least one social network, to determine a player's popularity on a position and policy, to determine shifts in the digital community's concerns therein determining what issues/policies are important to members of the digital community, where popularity trends are used by the incumbent position holder to formulate strategies necessary to retain his position (for instance against a hostile takeover attempt by other players), wherein in situations where a player has gained such popularity, celebrity, or recognition, for instance through charitable activities and contributions, and donations to the clear shadow organization, a popular player is awarded a commendation, the commendation typically is in the form being appointed to a high ranking policy position.

Rewarding a real entity, such as players and non-players, that perform acts that enhance transparency, wherein the real entity can elect to remain anonymous;

The method can further include: Matching players with positions in the clear shadow organization, where in general a potential player considers his interests, the costs of the game stock, social and networking considerations, and whether the available positions are a fit, where as a partial owner in the clear shadow organization the player can positively influence the future of the organization, and work with other players having similar interests (and possibly similar views);

Receiving acknowledgement for contributions when the real organization or the clear shadow organization receives a better composite transparency index, where the composite transparency index includes financial, public image, personal or religious freedom, wherein acknowledgement can come in the form of rewards, such as game coinage or actual currency, or shares in the real and shadow organization, or elevation to a higher policy making position, and voting support by other shareholders;

Maximizing and retaining a players policy making position, where the player retains his position after an election so long as he does not convert his shares to a reward, wherein the player as a candidate for a policy position upon winning the election is declared a winner, and therefore he is an employee of the organization in the elected position, and as a winner can occupy the position or he can vacate the newly won position converting his game shares and receiving a commensurate reward in the form of actual money or real shares, (wherein a runner-up player can move into the policy making position), and in a special case where the policy making position is a member on the board the winning player is declared a board member and accrues in rank, where as a member of the board the player can join one more clear shadow organizations, where a player's rank increases every time he becomes a member of another board; wherein only a sitting board member can own stock in more than one organization; and

Conducting elections on a frequent basis, where policies or policy changes for the various policy making positions are published, therein giving players the opportunity to support the occupant of the position in a vote, by voting for him during a round of elections, or voting in a new occupant, where the elections reflect the popularity of the policies of the player occupying the position in the clear shadow organization.

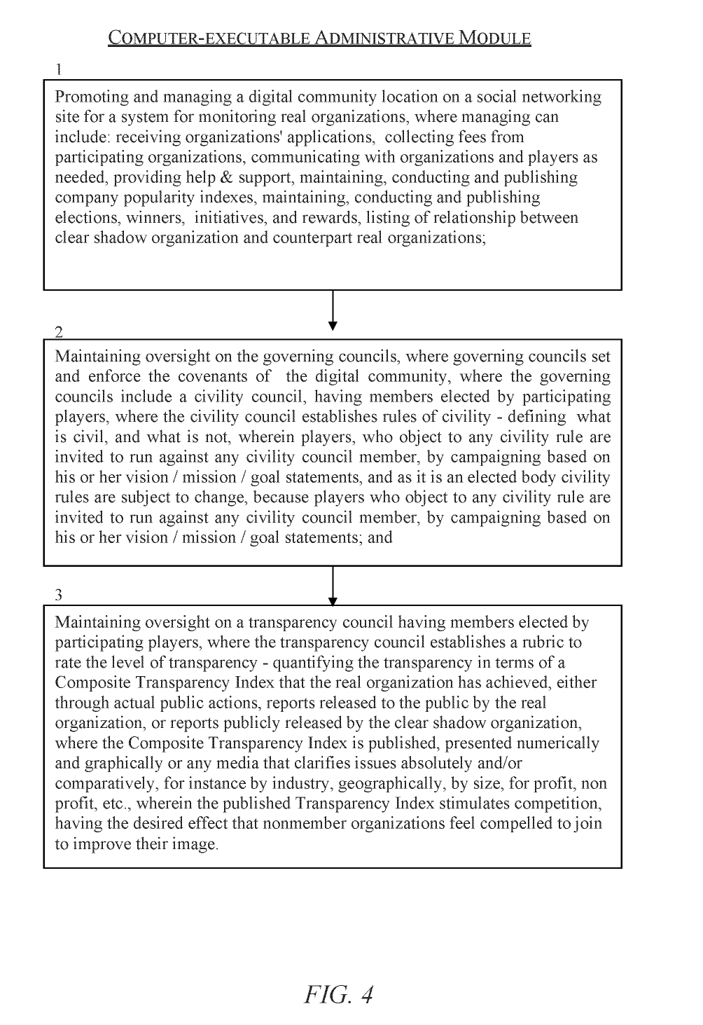

Referring to FIG. 4, the method includes: Promoting and managing a digital community location on a social networking site for a system for monitoring real organizations, where managing can include receiving organizations applications, collecting fees from participating organizations, communicating with organizations and players as needed, providing help and support, maintaining, conducting and publishing organization popularity indexes, maintaining, conducting and publishing elections, winners, initiatives, and rewards, listing of relationship between clear shadow organization and counterpart real organizations;

Maintaining oversight on the governing councils, where governing councils set and enforce the covenants of the digital community, where the governing councils include a civility council, having members elected by participating players, where the civility council establishes rules of civility—defining what is civil, and what is not, wherein players, who object to any civility rule are invited to run against any civility council member, by campaigning based on his or her vision/mission/goal statements, and because it is an elected body civility rules are subject to change, as players, who object to any civility rule are invited to run against any civility council member, by campaigning based on his or her vision/mission/goal statements; and

Maintaining oversight on a transparency council, having members elected by participating players, where the transparency council establishes a rubric to rate the level of transparency—quantifying the transparency in terms of a Composite Transparency Index that the real organization has achieved, either through actual public actions, reports released to the public by the real organization, or reports publicly released by the clear shadow organization, where the Composite Transparency Index is published, presented numerically and graphically or any media that clarifies issues absolutely and/or comparatively, for instance by industry, geographically, by size, for profit, non profit, etc., wherein the published Transparency Index stimulates competition, having the desired effect that nonmember organizations feel compelled to join to improve their image.

On occasion some entity or some organization will not think that the clear shadow organization is doing a very good job, and the entity or organization can form a dissenting clear shadow organization, defining its differences. Potentially, these adversarial organizations can find common ground and merge.

Below are some examples where clear shadow organizations may have some applications.

In a first example, there are two camps as to whether the Armenian Genocide, during and just after World War One, was perpetrated by the Ottoman Empire, or as some historians argue it was brought on by the Armenians, who were working with Russia, Turkey's most bitter foe; and therefore it is some peoples contention that the Armenians had to be regarded as rebels. Ninety five years after WWI there is still no consensus between the Turkish government and the Armenians. Following the ejection of the Russians from Turkey, the Turks brutally treated the Armenians as revolutionists, but most argue this was without cause. It has been argued that the Armenian's association with Russia was a just basis for the brutal treatment. In the context of the invention then two clear shadow organizations may now be formed, one by the Turks and one by the Armenians. Hopefully, after full disclosure these two organizations can find some common ground.

In a second example Toyota, as it turns out has had a lengthy history of manufacturing cars that can spontaneously accelerate. A clear shadow organization sponsored by Toyota would have been more objective, and seen the folly of trying to hide the spontaneous acceleration flaw, instead of trying to mitigate the problem by using misinformation that the identified cause was faulty car mats. It wasn't until several people were killed, and the surfacing of Toyota engineer's ten year old report outlining the problem as electrical did Toyota admit to its culpability.

In a third example, Martha Stuart went to jail for lying to Federal Officials, not for the act of insider trading, for which she was being questioned. A shadow organization representing her would have immediately known that the cover-up (lying to Federal Officials) was worst than the deed (insider trading). Richard Nixon set that precedence 35 years ago.

It is to be understood that the foregoing description and specific embodiments are merely illustrative of the best mode of the invention and the principles thereof, and that various modifications and additions may be made to the invention by those skilled in the art, without departing from the spirit and scope of this invention, which is therefore understood to be limited only by the scope of the appended claims.

What is claimed is:

1. A system for monitoring real organizations, said system comprises:
a digital community on a social network, where the digital community is comprised of participating member organizations which like a shadow, track the operations of a real organization, where a shadow organization promotes transparency of a counterpart real organization's operations by illuminating, scrutinizing and informing a global public forum of the actions of the counterpart real organization;
a player, where the player is a voting citizen member of the digital community, and can optionally actively participate as an employee and an ownership role in his selected clear shadow organization;
a code of civility that all members must abide by to maintain membership, where a civility council establishes the rules of civility; and
a composite transparency index, which is comprised of multiple indicators of the real organization's effort to openly and clearly disclose its operations, where the disclosure is typically through its clear shadow organization.

2. The system according to claim 1 further comprised of a transparency council, which establishes indicators to rate the level of transparency—quantifying the transparency in terms of the composite transparency index for the real organization, where the composite transparency index is published for view by the public

3. The system according to claim 1, wherein players who object to any civility rule are invited to run against any civility council member, by campaigning based on his or her vision/mission/goal statements.

4. The system according to claim 1, wherein the shadow organization is sponsored by the real organization.

5. The system according to claim 1 further comprised of a real entity, wherein the real entity is a founder of a shadow organization, where the real organization does not support the formation of the shadow organization, but cannot prevent the real entity from founding the unsponsored clear shadow organization.

6. The system according to claim 5, wherein the real entity is selected from the group consisting of an individual, a company, an association of companies, a lobbyist, a politician, a country, a state, a city, a county, a church, a governmental agency, a citizen, a club and an activist.

7. The system according to claim 1 further comprised of a third party, such as a real entity, a real organization or a shadow organization that believes that the exiting shadow organization is not promoting transparency, and the third party forms a third party clear shadow organization to enhance forthcoming transparency.

8. The system according to claim 1, wherein the player is rewarded for contributing his/her personal assets and involvement, with rewards being commensurately larger for attaining higher policy making positions in the shadow organization.

9. The system according to claim 1, wherein the player is rewarded if they attain a higher policy making position or if the policy making position improves the real organization's image, such as by solving problems and mitigating poor corporate behavior, such as hiding quality defects, secret payments, financial improprieties, religious, racial and moral intolerance, and abuse.

10. A computer-readable medium having a computer-executable application for a digital community of participating members of a game running on a social network, that when executed on at least one processor comprises:
a computer-executable module for a real organization to establish a clear shadow organization that is sponsored by the real organization, where the sponsored clear shadow organization is a transparent projection of the operations and activities of the real organization;
a computer-executable module for a real entity to establish an unsponsored clear shadow organization, where the unsponsored clear shadow organization, with or without the blessing of the shadowed real organization, attempts to disclose an accurate transparent projection of the operations and activities of the real organization;
a computer-executable module for a player to conduct transactions with real and clear shadow organizations and optionally to participate as an employee in clear shadow organizations in various positions, where some of the positions have policy making power; and
a computer-executable administrative module for managing the digital community governing councils, transactions for participating organizations, entities and players.

11. The computer-readable medium having a computer-executable application according to claim 10, wherein said computer-executable administrative module is an element of a social networking site.

12. The computer-readable medium having a computer-executable application according to claim 10, wherein the application is a game hosted on the social networking site.

13. The computer-readable medium having a computer-executable application according to claim 12, wherein the goal of playing the game is to accumulating shares or game coinage from the participating organizations, and possibly contributing to the policy of an organization, and potentially meeting other players with a similar interest.

14. A method for a system that monitors real organizations, said method comprising:
Forming a clear shadow organization, where a real organization is a sponsor and a founder, wherein the clear shadow organization is created and exists in a digital community on a social network, and the sponsored clear shadow organization has voting shares of a game stock and a game coinage;
Entering parameters in one of several templates generated by a computer executable administration module, where the parameters generally address issues to attract players, such as the clear shadow organization's position on social, political, commercial issues, the clear shadow organization's mission statement, goals, position on social, political, commercial issues, cost per game share, number of game shares, a ranking (per policy power) of positions, a set of clear shadow organization rules, a number of employees and a cost per game share, where a game share can have a par value or a value indexed to the real organization's shares, a level of difficulty to achieve goals and open positions, where the clear shadow organization reflects current positions of the real organization;
Encouraging players to join the clear shadow organization as an employee and a voting shareholder, where a policy making position requires a specified number of voting game shares, either personally owned or controlled by the player holding that position, and where elections are held frequently, said elections determining which players occupy what position, where the higher the position the greater the influence over policy, and the greater the potential for the player to accumulate more shares of game stock; and
Matching players with positions in the clear shadow organization, where the players considers his interests, the costs of the game stock, social and networking considerations, and whether the available positions are a fit, where as a partial owner the player can positively influence the future of the organization, and work with other players? having similar interests (and possibly similar views).

15. The method according to claim 14 further comprising:
Receiving acknowledgement for contributions when the organization receives a higher composite transparency index, where the index includes financial, public image, personal and religious freedom, wherein acknowledgement can come in the form of stock in the real and clear shadow organization, elevation to higher policy making position, and voting support by other shareholders;
Maximizing and retaining a player's policy making position, where the player as a candidate for an elected policy position wins the election, wherein as a winner he has several options including a first option of converting his game shares and receiving a commensurate reward in the form of actual money or real shares, therein making a runner up next in line to assume his position, and if the player is elected as a member of the board then he accrues in rank, where each time a player is declared a board member, he then has an option of joining a second organization and further increasing his rank if he becomes a board member on the second shadow organization, where only board members can trade in more than one organization, while a non-board member player must sell all his shares in one organization in order to buy shares in another organization;
Conducting elections on a frequent basis, where policies or policy changes for various policy making positions are published, thereby giving players the opportunity to support the occupant of a position in an election, by voting their shares of stock for him during the election, or supporting a potentially new occupant, where the elections reflect the popularity of the policies of the player; and
Displaying election winners, organization positions players have held, shares of a shadow organization they own and real shares of the real organization they own.

16. The method according to claim 15 further comprising:
Displaying past, current and projected number of voting shares of stock to gain posted positions, and instructions on how to participate;
Posting the shadow organization's public relations materials, organization news, and advertising;
Publishing the rules on how campaign donations of real money and game coinage to players and to shadow organizations are made, and rules on how voting game shares are voted;
Harvesting ideas from players;
Publishing how many game coins and game shares were given to players rewarded for their ideas;
Publishing the price of the real stock, and where it is traded;
Publishing a share multiplier parameter, where the share multiplier parameter determines how many game coins it takes to buy a share of the real organization at that particular time; and
Tracking and publishing employment statistics for the clear shadow organization, selected from the composite transparency index: including Total to-date players, Total year-to-date players, Total current players, Total game shares bought (with game coins) To-date, Year-to-date, Total converted shares (redeemed prizes) To-date, Year-to-date, Total policy making positions, Total policy making positions currently held, Total policy making positions currently available, and number of policy making position levels; and
Publishing the clear shadow organization's overall composite transparency indexes average based on all its ratings, and a composite transparency index of the real organization that is being shadowed.

17. The method according to claim 16 further comprising:
Evaluating the organizations' policies, and in particular the policies for filled positions within an organization where an election is imminent and the current occupant of the policy making position has published his position policy, and evaluating vacant positions that are currently available for a certain number of game shares or game coinage, where a sponsored organization has issued a starting policy;
Purchasing the vacant position or campaigning for the filled position, or pitch a real organization to sponsor an unsponsored shadow organization (therein creating positions) or, alternatively, issuing an initiative, collecting signatures, and forcing a vote on the initiative, where if the initiative prevails, it becomes a policy, and the initiating party gains the position, the policy is implemented, or if it fails it is recorded that the initiating party was rebuked;
Surveying the digital community, especially at least one social network, to determine a player's popularity on a position and policy, to determine shifts in the digital community's concerns to determine what issues/policies are important to them, where popularity trends are used by the incumbent position holder to formulate strategies necessary to retain his position in the case of a hostile takeover attempt by other players, wherein cases where a player has gained such popularity, celebrity, or recognition within the digital community, for instance such as through charitable activities and contributions, donations to the clear shadow organization, the player is awarded a commendation, typically in the form of a high ranking policy position.

18. The method according to claim 17 further comprising:
Rewarding a real entity, such as players and non-players, that perform acts that enhance transparency, where the real entity can remain anonymous or at a later time elect to be recognized for the act that enhanced transparency;
Matching players with positions in the clear shadow organization, where in general a potential player considers his interests, the costs of the game stock, social and networking considerations, and whether the available positions are a fit, where as a partial owner in the clear shadow organization the player can positively influence the future of the organization, and work with other players having similar interests (and possibly similar views);
Receiving acknowledgement for contributions when the real organization or the clear shadow organization receives a better composite transparency index, where the composite transparency index includes financial, public image, personal or religious freedom, wherein acknowledgement can come in the form of rewards, such as game coinage or actual currency, or shares in the real and shadow organization, or elevation to a higher policy making position, and voting support by other shareholders;
Maximizing and retaining a player's policy making position, where the player retains his position after an election so long as he does not convert his shares to a reward, wherein the player as a candidate for a policy position upon winning the election is declared a winner, and therefore he is an employee of the organization in the elected position, and as a winner can occupy the position or he can vacate the newly won position converting his game shares and receiving a commensurate reward in the form of actual money or real shares, (wherein a runner-up player can move into the policy making position), and in a special case where the policy making position is a member on the board the winning player is declared a board member and accrues in rank, where as a member of the board the player can join one more clear shadow organizations, where a player's rank increases every time he becomes a member of another board, wherein only a sitting board member can own stock in more than one organization; and
Conducting elections on a frequent basis, where new policies or policy changes for various policy making positions are published, and giving players the opportunity to support the occupant of a position in a vote, by voting for him during a round of elections, or voting in a new occupant, where the elections reflect the popularity of the policies of the player occupying the position in the clear shadow organization.

19. The method according to claim 14 further comprising:
Promoting and managing a digital community location on the social networking site for the system for monitoring real organizations, where managing comprises: receiving organizations' applications, collecting fees from participating organizations, communicating with organizations and players as needed, providing help & support, maintaining, conducting and publishing organization popularity indexes, maintaining, conducting and publishing elections, winners, initiatives, and rewards, listing of relationship between clear shadow organization and counterpart real organizations;
Maintaining oversight on the governing councils, where governing councils set and enforce the covenants of the digital community, where the governing councils include a civility council, having members elected by participating players, where the civility council establishes rules of civility—defining what is civil, and what is not, wherein players, who object to any civility rule are invited to run against any civility council member, by campaigning based on his or her vision/mission/goal statements, and because it is an elected body civility rules are subject to change, as players, who object to any civility rule are invited to run against any civility council member, by campaigning based on his or her vision/mission/goal statements; and
Maintaining oversight on a transparency council, having members elected by participating players, where the transparency council establishes a rubric to rate the level of transparency—quantifying the transparency in terms of a Composite Transparency Index that the real organization has achieved, either through actual public actions, reports released to the public by the real organization, or reports publicly released by the clear shadow organization, where the Composite Transparency Index is published, presented numerically and graphically on any media that clarifies issues absolutely and/or comparatively, for instance by industry, geographically, by size, for profit, non-profit, etc., wherein the published Transparency Index stimulates competition, having the desired effect that nonmember organizations feel compelled to join to improve their image.
